(19) United States
(12) Patent Application Publication
(10) Pub. No.: US 2017/0258119 A1
(43) Pub. Date: Sep. 14, 2017

(54) Device for Extending Shelf Life of a Fresh Product and Uses Thereof

(71) Applicant: FARMSPEC PTY LTD, Fullarton (AU)

(72) Inventor: Clinton George Ribbon, Fullarton (AU)

(21) Appl. No.: 15/507,492

(22) PCT Filed: Sep. 1, 2015
(86) PCT No.: PCT/AU2015/000533

§ 371 Date: Feb. 28, 2017

(30) Foreign Application Priority Data
Sep. 1, 2014 (AU) 2014903474

(51) Int. Cl. A23L 3/3409; A23L 3/3418; A23L 3/28; A23B 7/015; A23B 7/148

(52) U.S. Cl. CPC A23L 3/34095; A23B 7/015; A23B 7/148; A23L 3/28; A23L 3/3418; A23V 2002/00

(57) ABSTRACT

The present disclosure relates to an air modifying device for extending the shelf life of a fresh product and to methods of extending the shelf life of fresh products. Certain embodiments of the present disclosure comprise an air modifying device for extending shelf life of a fresh product. The device comprises a hollow body, one or more means for moving air or a gas through the hollow body, a surface within the hollow body, the surface comprising a metal oxide, and a source of UV light within the body to direct UV light onto the surface comprising the metal oxide, wherein irradiation of the metal oxide with the UV light modifies the air or gas moved through the device so that release of the modified air or gas from the device into the atmosphere around the fresh product extends the shelf life of the fresh product.

### PRIORITY CLAIM

This application claims priority to Australian provisional patent application number 2014903474 filed on 1 Sep. 2014, the content of which is hereby incorporated by reference.

### FIELD

The present disclosure relates to an air modifying device for extending the shelf life of a fresh product and to methods of extending the shelf life of fresh products.

### BACKGROUND

Extending the storage life of fresh produce is of considerable economic importance. Most fresh produce requires some form of storage before being passed on to the end consumer. For example, storage of fresh products is often required at the point of harvesting, post-harvest, during transport to the place of sale and at the place of sale. Having the fresh produce offered to the consumer in a form where its quality and/or appearance have not been comprised due to storage is therefore very important.

Most fresh produce undergoes some form of deterioration over time. For plant products, typically this takes the form of over-ripening and/or the action of pathogens or microorganisms on the fresh produce. For example, over time fruits progress past a point of ripening where the product is no longer saleable. In addition, the action of fungi from fungal spores may also lead to the formation of undesirable moulds on fresh products.

For many plant products, the production of ethylene is one of the main contributors to the ripening process. Storage in cold temperature is used to slow the ripening process. In addition, ethylene inhibitors are available that can be used to slow the ripening process. For example, 1-methylcyclopropene is a volatile product that is used in storage rooms to slow the ripening process by release of the product into the atmosphere.

Aside from the efforts to slow the ripening process in plant products, the economic costs in providing an environment to slow deterioration of products and/or to get products to market before deterioration are also significant. For example, significant costs are borne by the need to store produce at cool or cold temperatures, and quick and efficient transportation is typically used to deliver the produce to its point of sale as soon as possible. Any improvements in the ability to slow or delay deterioration and/or an improvement in the conditions needed to slow or delay deterioration also provide important economic benefits.

Accordingly, there is a need for new means to extend the shelf life of fresh products.

### SUMMARY

The present disclosure relates to an air modifying device for extending the shelf life of a fresh product and to methods of extending the shelf life of fresh produce.

Certain embodiments of the present disclosure comprise an air modifying device for extending shelf life of a fresh product, the device comprising:
a hollow body;
one or more means for moving air or a gas through the hollow body;
a surface within the hollow body, the surface comprising a metal oxide; and
a source of UV light within the body to direct UV light onto the surface comprising the metal oxide;

wherein irradiation of the metal oxide with the UV light modifies the air or gas moved through the device so that release of the modified air or gas from the device into the atmosphere around the fresh product extends the shelf life of the fresh product.
Certain embodiments of the present disclosure provide an air modifying device for extending shelf life of a fresh plant product, the device comprising:
a hollow body;
one or more means for moving air or a gas through the hollow body;
a surface within the hollow body, the surface comprising a metal oxide; and
a source of UV light within the body to direct UV light onto the surface comprising the metal oxide;
   wherein irradiation of the metal oxide with the UV light produces nitric oxide from the air or the gas thereby modifying the air or gas released by the device so as to extend the shelf life of the fresh plant product.

Certain embodiments of the present disclosure provide an air modifying device for extending shelf life of a fresh product, the device comprising:
a metal tube, wherein an inner surface of the tube has been chemically scored and coated with a titanium oxide and/or a zinc oxide;
a fan for moving air or a gas through the metal tube; and
a source of UV light within the tube to direct UV light onto the inner surface coated with a titanium oxide and/or a zinc oxide.

Certain embodiments of the present disclosure provide a method for extending the shelf life a fresh product, the method comprising modifying the air in which the fresh product is present using a device as described herein to modify the air, thereby extending the shelf life of the fresh product.

Certain embodiments of the present disclosure provide a method for extending the shelf life a fresh plant product, the method comprising:
producing nitric oxide catalytically from air or a gas by irradiating a metal oxide with UV light; and
releasing the catalytically produced nitric oxide into the atmosphere around the fresh plant product, thereby exposing the fresh plant product to the nitric oxide and extending the shelf life of the fresh plant product.

Certain embodiments of the present disclosure provide a method for extending the shelf life of a fresh product, the method comprising modifying the air in which the fresh product is present by treating the air using UV irradiation in the presence of a metal oxide, thereby extending the shelf life of the fresh product.

Other embodiments are disclosed herein.

### BRIEF DESCRIPTION OF THE FIGURES

Certain embodiments are illustrated by the following figures. It is to be understood that the following description is for the purpose of describing particular embodiments only and is not intended to be limiting with respect to the description.

FIG. 1 shows an external view of an air modifying device according to one embodiment.

FIG. 2 shows a schematic view of the inside of an air modifying device according to one embodiment.

FIG. 3 shows an exploded view of the components of an air modifying device according to one embodiment.

FIG. 4 shows the results of the use of the device to modify air.

### DETAILED DESCRIPTION

The present disclosure relates to an air modifying device for extending the shelf life of a fresh product and to methods of extending the shelf life of fresh produce.

Certain embodiments of the present disclosure provide an air modifying device for extending shelf life of a fresh product.

Certain embodiments of the present disclosure provide an air modifying device for extending shelf life of a fresh product, the device comprising:
a hollow body;
one or more means for moving air or a gas through the hollow body;
a surface within the hollow body, the surface comprising a metal oxide; and
a source of UV light within the body to direct UV light onto the surface comprising the metal oxide;
   wherein irradiation of the metal oxide with the UV light modifies the air or gas moved through the device so that release of the modified air or gas from the device into the atmosphere around the fresh product extends the shelf life of the fresh product.

In certain embodiments, irradiation of the metal oxide with the UV light produces nitric oxide from the air or the gas thereby modifying the air or gas released by the device.

In certain embodiments, the device produces an output concentration of nitric oxide of greater than 0.25 ppm. In certain embodiments, the device produces an output concentration of nitric oxide of greater than 0.5 ppm. In certain embodiments, the device produces an output concentration of nitric oxide of greater than 1.0 ppm. In certain embodiments, the device produces an output concentration of nitric oxide of greater than 1.5 ppm. In certain embodiments, the device produces an output concentration of nitric oxide of greater than 2.0 ppm. Other amounts are contemplated.

In certain embodiments, the device produces an output concentration of nitric oxide of 0.25 ppm or greater, 0.5 ppm or greater, 1.0 ppm or greater, 1.5 ppm or greater, 2.0 ppm or greater. Other amounts are contemplated.

In certain embodiments, the device produces an output concentration of nitric oxide of in the range from 0.5 to 2.0 ppm, 1.0 to 2.0 ppm. 1.5 to 2.0 ppm, 1.0 to 2.00 ppm or 1.5 to 2.0 ppm. Other ranges are contemplated.

In certain embodiments, the device operates in a controlled atmosphere setting. In certain embodiments, the controlled atmosphere setting comprises a cool room, a cold room or a storage room. In certain embodiments, the device operates in a storage container or a shipping container. In certain embodiments, the device operates in a greenhouse. In certain embodiments, the device operates in a trucking container. Other types of closed settings or systems are contemplated.

In certain embodiments, the device provides a concentration of nitric oxide in the atmosphere of 0.25 ppm or greater. In certain embodiments, the device produces a concentration of nitric oxide in the atmosphere of 0.5 ppm or greater. In certain embodiments, the device provides a concentration of nitric oxide in the atmosphere of 1.0 ppm or greater. In certain embodiments, the device provides a concentration of nitric oxide in the atmosphere of 1.5 ppm or greater. In certain embodiments, the device provides a concentration of nitric oxide in the atmosphere of 2.0 ppm or greater.

In certain embodiments, the device provides a concentration of nitric oxide in the atmosphere of 0.25 ppm or greater, 0.5 ppm or greater, 1.0 ppm or greater, 1.5 ppm or greater, 2.0 ppm or greater. Other amounts are contemplated.

In certain embodiments, in a closed setting or system, the device produces a concentration of nitric oxide in the atmosphere in the range from 0.5 to 2.0 ppm, 1.0 to 2.0 ppm. 1.5 to 2.0 ppm, 1.0 to 2.00 ppm or 1.5 to 2.0 ppm.

In certain embodiments, the device operates in a setting held at ambient temperature, 25° C. or less, 20° C. or less, 15° C. or less, 10° C. or less, 4° C. or less, or 2° C. or less. Other temperatures are contemplated.

In certain embodiments, the device operates in a normal oxygen environment or atmosphere, (i.e. around 21% oxygen). In certain embodiments, the device operates in a low oxygen environment or atmosphere. In certain embodiments, the device operates in an atmosphere comprising 5% oxygen or less. In certain embodiments, the device operates in an atmosphere comprising 2% oxygen or less.

In certain embodiments, the device operates continuously. In certain embodiments, the device operates continuously in a controlled atmosphere setting. In certain embodiments, the device operates intermittently. In certain embodiments, the device operates intermittently in a controlled atmosphere setting.

In certain embodiments, the device operates for 1 hour or greater, 6 hours or greater, 12 hours or greater, 18 hours or greater, 1 day or greater, 2 days or greater, or 1 week or greater.

In certain embodiments, the device operates to reduce ethylene and/or volatile organic compounds in the air or the gas, thereby modifying the air or gas released by the device so as to extend the shelf life of the fresh product.

In certain embodiments, the device reduces the concentration of volatile organic compounds in the atmosphere to 25 ppm or less, or 20 ppm or less. In certain embodiments, the device reduces the concentration of volatile organic compounds in a controlled atmosphere setting containing fruit to 25 ppm or less, or 20 ppm or less.

In certain embodiments, the device reduces the concentration of ethylene in the atmosphere to 10.0 ppm or less, 6.0 ppm or less, 5.0 ppm or less or 2.0 ppm or less. In certain embodiments, the device reduces the concentration of volatile organic compounds in a controlled atmosphere setting containing fruit to 10.0 ppm or less, 6.0 ppm or less, 5.0 ppm or less, or 2.0 ppm or less.

In certain embodiments, irradiation with the UV light reduces ethylene and/or volatile organic compounds in the air or the gas thereby modifying the air or gas released by the device so as to extend the shelf life of the fresh product.

In certain embodiments, the device operates to reduce the concentration microorganisms in the air or the gas, thereby modifying the air or gas released by the device so as to extend the shelf life of the fresh product.

In certain embodiments, irradiation with the UV light reduces microorganisms from the air or the gas thereby modifying the air or gas released by the device so as to extend the shelf life of the fresh product. Examples of microorganisms include spores, viruses, fungi and bacteria.

In certain embodiments, the device reduces the concentration of microorganisms in the atmosphere.

In certain embodiment, the hollow body comprises a tube. Other configurations of the hollow body are contemplated.

In certain embodiments, the tube comprises a substantially cylindrical tube. Other configurations are contemplated, including tubes having a rectangular, square or oval cross-section.

In certain embodiments, the hollow body comprises a length of 50 cm to 300 cm. In certain embodiments, the hollow body comprises a length of 100 cm to 300 cm, 100 cm to 200 cm or 200 to 300 cm. Other lengths are contemplated.

In certain embodiments, the tube comprises a length of 50 cm to 300 cm. In certain embodiments, the tube comprises a length of 100 cm to 300 cm, 100 cm to 200 cm or 200 to 300 cm.

In certain embodiments, the tube comprises an outer diameter of 10 to 30 cm. Other sizes are contemplated.

In certain embodiments, the one or more means for moving air or a gas through the hollow body comprises one or more fans. Other means are contemplated, such as a source of air or a gas held under pressure, and directed into the device.

In certain embodiments, the fan pushes air or gas through the device. In certain embodiments, the fan draws air or gas through the device. In certain embodiments, the device comprises a single fan. In certain embodiments, the device comprises two or more fans.

In certain embodiments, the device comprises a fan to push air or gas through the hollow body. In certain embodiments, the device comprises a fan to push air or gas through the hollow tube. In certain embodiments, the device comprises a fan at one end of the hollow tube to push air or gas through the tube.

In certain embodiments, the fan comprises a power of 10 to 50 W. In certain embodiments, the fan comprises a power of 20 to 50 W, 30 to 50 W, 40 to 50 W, 10 to 50 W, 20 to 40 W, 30 to 40 W, 10 to 30 W, 20 to 30 W, or 10 to 20 W. Other power outputs are contemplated.

In certain embodiments, the fan comprises a power of 10 W or greater, 20 W or greater, 30 W or greater, 40 W or greater, or 50 W or greater.

In certain embodiments, the one or more means for moving air or a gas through the hollow body produces an air or gas flow of 25 to 100 m³ per minute. In certain embodiments, the one or more means for moving air or a gas through the hollow body produces a flow of 50 to 100 m³ per minute, 75 to 100 m³ per minute, 25 to 75 m³ per minute, 50 to 75 m³ per minute, or 25 to 50 m³ per minute. Other flow rates are contemplated.

In certain embodiments, the one or more means for moving air or a gas through the hollow body produces an air or gas flow of 10 m³ per minute or greater, 25 m³ per minute or greater, 50 m³ per minute or greater, 75 m³ per minute or greater, or 100 m³ per minute or greater.

In certain embodiments, the one or more means for moving air or a gas through the hollow body comprises a fan and the fan produces a flow of 25 to 100 m³ per minute. In certain embodiments, the fan produces a flow of 50 to 100 m³ per minute, 75 to 100 m³ per minute, 25 to 75 m³ per minute, 50 to 75 m³ per minute, or 25 to 50 m³ per minute.

In certain embodiments, the one or more means for moving air or a gas through the hollow body comprises a fan and the fan produces an air flow of 10 m³ per minute or greater, 25 m³ per minute or greater, 50 m³ per minute or greater, 75 m³ per minute or greater, or 100 m³ per minute or greater.

In certain embodiments, the surface comprising a metal oxide comprises a surface embedded with a metal oxide(s).

In certain embodiments, the surface comprising a metal oxide comprises a surface coated with a metal oxide(s).

In certain embodiments, the method of coating comprises dipping the surface to be coated in a solution of the metal oxide(s). In certain embodiments, the method of coating comprises painting and/or spraying the surface to be coated with a solution of the metal oxide(s). In certain embodiments, the method of coating comprises dipping the surface to be coated in a solution of the metal oxide(s) and drying the surface. In certain embodiments, the method of coating comprises painting and/or spraying the surface to be coated with a solution of the metal oxide(s) and drying the surface. In certain embodiments, the surface comprises one or more coatings.

In certain embodiments, the metal oxide comprises one or more of a zinc oxide, a titanium oxide, a manganese oxide and a cerium oxide. Other metal oxides and combinations of metal oxides are contemplated.

In certain embodiments, the metal oxide comprises a zinc oxide.

In certain embodiments, the metal oxide comprises a titanium oxide. In certain embodiments, the metal oxide comprises a rutile titanium oxide. In certain embodiments, the titanium dioxide comprises an anatase titanium oxide. In certain embodiments, the metal oxide comprises a rutile titanium oxide and an anatase titanium oxide.

In certain embodiments, the metal oxide comprises a zinc oxide and/or a titanium oxide. In certain embodiments, the metal oxide comprises a rutile titanium oxide and/or an anatase titanium oxide.

In certain embodiments, the metal oxide comprises a rutile titanium oxide, an anatase titanium oxide and a zinc oxide.

In certain embodiments, the surface comprising a metal oxide comprises one or more undercoats of a metal oxide(s).

In certain embodiments, the surface comprising a metal oxide comprises one or more undercoats of a metal oxide(s) and one or more overcoats of a metal oxide(s).

In certain embodiments, the undercoat comprises an undercoat comprising a zinc oxide. In certain embodiments, the undercoat comprises an undercoat of a manganese oxide. In certain embodiments, the undercoat comprises an undercoat of a zinc oxide and/or a manganese oxide and/or a cerium oxide.

In certain embodiments, the metal oxide comprises an undercoat of a zinc oxide and an overcoat of a rutile titanium oxide, an anatase titanium oxide and a zinc oxide.

In certain embodiments, the metal oxide comprises particulates of a size of less than 500 μm. In certain embodiments, the metal oxide comprises particulates of a size of 500 μm or less.

In certain embodiments, the metal oxide comprises particulates of a size of less than 500 μm, less than 400 μm, less than 300 μm, less than 200 μm, less than 100 μm, less than 900 nm, less than 800 nm, less than 700 nm, less than 600 nm, less than 500 nm, less than 400 nm, less than 300 nm, less than 200 nm, less than 100 nm, less than 75 nm, less than 50 nm, less than 40 nm, less than 30 nm, less than 20 nm or less than 10 nm. Other sizes are contemplated.

In certain embodiments, the metal oxide comprises particulates of a size 500 μm or less, 400 μm or less, 300 μm or less, 200 μm or less, 100 μm or less, 900 nm or less, 800 nm or less, 700 nm or less, 600 nm or less, 500 nm or less, 400 nm or less, 300 nm or less, 200 nm or less, 100 nm or less, 75 nm or less, 50 nm or less, 40 nm or less, 30 nm or less, 20 nm or less, or 10 nm or less. Other sizes are contemplated.

In certain embodiments, the hollow body comprises a metal and/or a metal alloy. In certain embodiments, the hollow body is composed of a metal and/or a metal alloy. Other types of materials are contemplated, for example a glass. In certain embodiments, the hollow body is a tube and the tube is composed of a metal and/or a metal allow.

In certain embodiments, the hollow body is composed of a steel, such as a stainless steel. In certain embodiments, the hollow body is a tube and the tube is composed of a steel, such as a stainless steel.

In certain embodiments, the surface within the hollow body comprising a metal oxide comprises an inner surface of the hollow body. For example, all or part of the inside surface of a tube may be coated with the metal oxide(s).

In certain embodiments, the surface within the hollow body comprising a metal oxide comprises an insert (for example a sleeve) which can be placed inside the hollow body. In certain embodiments, the surface within the hollow body comprising a metal oxide comprises one or more plates placed inside the hollow body.

In certain embodiments, the surface within the hollow body comprising a metal oxide comprises all or part of the inner surface of the hollow body. In certain embodiments, the surface within the hollow body comprising a metal oxide comprises substantially the entire inner surface of the hollow body.

In certain embodiments, the surface within the tube comprising a metal oxide comprises substantially the entire inner/inside surface of the tube.

In certain embodiments, the surface within the hollow body comprising a metal oxide is scored and/or treated prior to coating with the metal oxide.

In certain embodiments, the surface within the hollow body comprising a metal oxide is scored prior to coating with the metal oxide. In certain embodiments, the surface within the hollow body comprising a metal oxide is chemically scored or etched prior to coating with the metal oxide. In certain embodiments, the surface within the hollow body comprising a metal oxide is mechanically scored or etched prior to coating with the metal oxide.

In certain embodiments, the surface comprising a metal oxide is scored or treated with a solution of an acid and/or a salt. Examples of salts include ferric chloride or copper sulphate.

In certain embodiments, the surface comprising a metal oxide is scored or treated with an acid. Examples of acids include hydrochloric acid, nitric acid, or sulphuric acid, which can be used to chemically treat the surface to score or etch the surface.

In certain embodiments, the surface comprising a metal oxide is scored or treated with a solution of a ferric salt and/or a detergent.

In certain embodiments, the ferric salt comprises ferric chloride. Other ferric salts are contemplated.

In certain embodiments, the solution for scoring comprises a concentration of ferric salt of 10 to 25% (w/w). In certain embodiments, the solution for scoring comprises a concentration of ferric salt of 15 to 25% (w/w), 20 to 25% (w/w), 10 to 20% (w/w), 15 to 20% (w/w), or 10 to 15% (w/w). Other amounts are contemplated.

In certain embodiments, the solution for scoring comprises a concentration of detergent of 2 to 5% (w/w). In certain embodiments, the solution comprises a concentration of detergent of 1 to 5% (w/w), 2 to 5% (w/w), 3 to 5% (w/w), 4 to 5% (w/w), 1 to 4% (w/w), 2 to 4% (w/w), 4 to 4% (w/w), 1 to 3% (w/w), 2 to 3% (w/w) or 1 to 2% (w/w). Other amounts are contemplated.

In certain embodiments, the detergent comprises an anionic detergent. In certain embodiments, the detergent comprises sodium laurel sulphate and/or a derivative thereof. Other types of detergents are contemplated.

In certain embodiments, the source of UV light comprises a UV-C light source. In certain embodiments, the source of UV light emits light in a range from 100 to 290 nm. In certain embodiments, the source of UV light comprises a UV-C lamp or tube. In certain embodiments, the source of UV light has a power output of 8 W or greater, 10 W or greater, 20 W or greater, 30 W or greater, 40 W or greater, 50 W or greater, 60 W or greater, or 70 W or greater.

In certain embodiments, the device produces substantially no ozone.

In certain embodiments, the device in use reduces the concentration of ethylene in the air or atmosphere, generates NO, reduces the concentration of volatile organic compounds in the air or atmosphere, reduces the rate of deterioration of a fresh product, and/or reduces the concentration of viable microorganisms in the air or atmosphere, including spores, in the air.

In certain embodiments, the fresh product is fresh plant product. Examples of fresh plant products include post-harvest products, products being stored, products being transported and products at the point of sale.

In certain embodiments, the fresh product comprises a non-plant product. Examples include products such as fresh meats, chicken, cheeses and other dairy products, dried produce, dried meats, smoked products and cured meats. Other types of fresh products are contemplated.

In certain embodiments, the fresh plant product is a product that is susceptible to an ethylene response. In certain embodiments, the fresh plant product is a product that is susceptible to spoilage, deterioration, decay, softening, discolouration or moulding. In certain embodiments, the fresh plant product is a product that is susceptible to the action of a microorganism present in the air.

In certain embodiments, the fresh plant product comprises a whole plant. In certain embodiments, the fresh plant product comprises a part or portion of a plant.

In certain embodiments, a whole plant comprises one or more of an ornamental plant, a potted plant, a nursery plant, a tree, a shrub, a foliage plant, a flowering plant, a greenery plant, a field crop, a landscape plant, and an agricultural plant.

Examples of plants comprise cotton (Gossypium spp.), apples, pears, cherries (Prunus avium), pecans (Carva illinoensis), grapes (Vitis vinifera), olives (e.g. Vitis vinifera and Olea europaea), coffee (Coffea arabica), snapbeans (Phaseolus vulgaris), and weeping fig (ficus benjamina), as well as dormant seedlings such as dormant seedlings of various fruit trees including apple, ornamental plants, shrubbery, and tree seedlings. In addition, shrubs which may be treated according to the present invention to inhibit an ethylene response, such as abscission of foliage, include privet (Ligustrum sp.), photinea (Photinia sp.), holly (Ilex sp.), ferns of the family Polypodiaceae, schefflera (Schefflera sp.), aglaonema (Aglaonema sp.), cotoneaster (Cotoneaster sp.), barberry (Berberis sp.), waxmyrtle (Myrica sp.), abelia (Abelia sp.), acacia (Acacia sp.) and bromeliades of the family Bromeliaceae. Other types of plants are contemplated. In certain embodiments, the plant product comprises a part or portion of the aforementioned plants.

In certain embodiments, the fresh product is fresh plant product. In certain embodiments, the fresh plant product is a part of a plant product that is susceptible to an ethylene response. In certain embodiments, the fresh plant product is a part of a plant product that is susceptible to spoilage, deterioration, decay, softening, discolouration or moulding.

In certain embodiments, the fresh plant product comprises a whole plant. In certain embodiments, the plant product comprises a part or portion of a plant.

In certain embodiments, the device is used to inhibit an ethylene response, such as to inhibit abscission of foliage, flowers and fruit.

In certain embodiments, the device is used to inhibit an ethylene response, such as senescence and/or shortening of flower life and thus prolong flower life and appearance (e.g. delay wilting).

Examples of flowering plants comprise azalea (Rhododendron spp.), hydrangea (Macrophylla hydrangea), hybiscus (Hibiscus rosasanensis), snapdragons (Antirrhinum sp.), poinsettia (Euphorbia pulcherima), cactus (e.g. Cactaceae schlumbergera truncata), begonias (Begonia sp.), roses (Rosa spp.), tulips (Tulipa sp.), daffodils (Narcissus spp.), dandelions (Taraxacum offinale), petunias (Petunia hybrida), carnation (Dianthus caryophyllus), lily (e.g., Lilium sp.), gladiolus (Gladiolus sp.), alstroemeria (Alstoemeria brasiliensis), anemone (e.g., Anemone blanda), columbine (Aquilegia sp.), aralia (e.g., Aralia chinensis), aster (e.g., Aster carolinianus), bougainvillea (Bougainvillea sp.), camellia (Camellia sp.), bellflower (Campanula sp.), cockscomb (celosia sp.), falsecypress (Chamaecyparis sp.), chrysanthemum (Chrysanthemum sp.), clematis (Clematis sp.), cyclamen (Cyclamen sp.), freesia (e.g., Freesia refracta), and orchids of the family Orchidaceae. Other types of flowering plants are contemplated. Other types of plants are contemplated. In certain embodiments, the plant product comprises a part or portion of the aforementioned flowering plants, such as cut flowers.

In certain embodiments, the fresh plant product comprises a part or portion of a plant. In certain embodiments, the fresh plant product comprises a fruit, a vegetable, a cutting, and a cut flower. Other types of plant products are contemplated.

Examples of fruits comprise tomatoes (Lycopersicon esculentum), apples (Malus domestica), bananas (Musa sapientum), pears (Pyrus communis), papaya (Carica papaya), mangoes (Mangifera indica), peaches (Prunus persica), apricots (Prunus armeniaca), nectarines (Prunus persica nectarina), oranges (Citrus sp.), lemons (Citrus limonia), limes (Citrus aurantifolia), grapefruit (Citrus paradisi), tangerines (Citrus nobilis deliciosa), kiwi (Actinidia chinenus), melons such as cantaloupe (C. cantalupensis) and musk melon (C. melo), pineapple (Aranas comosus), persimmon (Diospyros sp.), various other fruits including stone fruits, and berries such as strawberries (Fragaria), blueberries (Vaccinium sp.) and raspberries (e.g., Rubus ursinus), green beans (Phaseolus vulgaris), members of the genus Cucumis such as cucumber (C. sativus), and avocados (Persea americana). Other types of fruits are contemplated.

Examples of vegetables comprise leafy green vegetables, such as lettuce (e.g., Lactuea sativa), spinach (Spinaca oleracea), and cabbage (Brassica oleracea), various roots, potatoes (Solanum tuberosum), carrots (Daucus), bulbs, onions (Allium sp.), herbs, basil (Ocimum basilicum), oregano (Origanum vulgare), dill (Anethum graveolens), soybean (Glycine max), lima beans (Phaseolus limensis), peas (Lathyrus spp.), corn (Zea mays), broccoli (Brassica oleracea italica), cauliflower (Brassica oleracea botrytis), and asparagus (Asparagus officinalis). Other types of vegetables are contemplated.

In certain embodiments, the fresh plant product comprises a part or portion of a plant. In certain embodiments, the device is used to inhibit an ethylene response, to slow ripening, to slow deterioration, to slow the growth of microorganisms, to slow spoilage, and to improve the quality or appearance of the product when stored.

In certain embodiments, the device is used to extend the shelf life of a fresh plant product selected from a fruit, a vegetable, a cut flower, an ornamental plant, a potted plant, a nursery plant, a tree, a shrub, a foliage plant, a flowering plant, and an agricultural plant. Other types of plants products are contemplated.

Certain embodiments of the present disclosure provide an air modifying device for extending shelf life of a fresh product, the device comprising:
a hollow body;
one or more means for moving air or a gas through the hollow body;
a surface within the hollow body, the surface comprising a metal oxide; and a
a source of UV light within the body to direct UV light onto the surface comprising the metal oxide;
   wherein irradiation of the metal oxide with the UV light produces nitric oxide from the air or the gas thereby modifying the air or gas released by the device so as to extend the shelf life of the fresh product.

Certain embodiments of the present disclosure provide an air modifying device for extending shelf life of a fresh plant product, the device comprising:
a hollow body;
one or more means for moving air or a gas through the hollow body;
a surface within the hollow body, the surface comprising a metal oxide; and a
a source of UV light within the body to direct UV light onto the surface comprising the metal oxide;
   wherein irradiation of the metal oxide with the UV light produces nitric oxide from the air or the gas thereby modifying the air or gas released by the device so as to extend the shelf life of the fresh plant product.

Certain embodiments of the present disclosure provide an air modifying device for extending shelf life of a fresh plant product, the device comprising:
a metal tube, wherein an inner surface of tube is coated with a metal oxide;
one or more fans for moving air or a gas through the tube; and
a source of UV light within the body to direct UV light onto the surface coated with the metal oxide;
   wherein irradiation of the metal oxide with the UV light produces nitric oxide from the air or the gas thereby modifying the air or gas released by the device so as to extend the shelf life of the fresh plant product.

Certain embodiments of the present disclosure provide an air modifying device for extending shelf life of a fresh product, the device comprising:
a metal tube, wherein an inner surface of the tube has been chemically scored and coated with a titanium oxide and/or a zinc oxide;
a fan for moving air or a gas through the metal tube; and
a source of UV light within the tube to direct UV light onto the inner surface coated with a titanium oxide and/or a zinc oxide.

Certain embodiments of the present disclosure provide a method for extending the shelf life a fresh product, the method comprising using an air modifying device as described herein.

Examples of fresh products are as described herein. In certain embodiments, the fresh product is fresh plant product. In certain embodiments, the fresh product comprises a non-plant product. Examples include products such as fresh meats, chicken, cheeses and other dairy products, dried produce, dried meats, smoked products and cured meats. Other types of fresh products are contemplated.

Certain embodiments of the present disclosure provide a method for extending the shelf life a fresh product, the method comprising modifying the air in which the fresh product is present using a device as described herein to modify the air, thereby extending the shelf life of the fresh product.

Certain embodiments of the present disclosure provide a method for extending the shelf life a fresh product, the method comprising modifying the air in which the fresh product is present by treating the air by irradiating a metal oxide with UV light, thereby extending the shelf life of the fresh product.

Certain embodiments of the present disclosure provide a method for extending the shelf life a fresh product, the method comprising:
producing nitric oxide catalytically from air or a gas by irradiating a metal oxide with UV light; and
releasing the catalytically produced nitric oxide into the atmosphere around the fresh product, thereby exposing the fresh product to the nitric oxide and extending the shelf life of the fresh product.

Certain embodiments of the present disclosure provide a method for extending the shelf life a fresh plant product, the method comprising:
producing nitric oxide catalytically from air or a gas by irradiating a metal oxide with UV light; and
releasing the catalytically produced nitric oxide into the atmosphere around the fresh plant product, thereby exposing the fresh plant product to the nitric oxide and extending the shelf life of the fresh plant product.

In certain embodiments, the method comprises producing a concentration in the atmosphere of nitric oxide of greater than 0.25 ppm, greater than 0.5 ppm, greater than 1.0 ppm, greater than 1.5 ppm, or greater than 2.0 ppm.

In certain embodiments, the method comprises producing a concentration in the atmosphere of nitric oxide of 0.25 ppm or greater, 0.5 ppm or greater, 1.0 ppm or greater, 1.5 ppm or greater, or 2.0 ppm or greater.

In certain embodiments, the method comprises producing a concentration in the atmosphere of nitric oxide in the range from 0.5 to 2.0 ppm, 1.0 to 2.0 ppm. 1.5 to 2.0 ppm, 1.0 to 2.00 ppm or 1.5 to 2.0 ppm. Other ranges are contemplated.

In certain embodiments, the catalytically produced nitric oxide is released into the atmosphere at a concentration of greater than 0.25 ppm, greater than 0.5 ppm, greater than 1.0 ppm, greater than 1.5 ppm, or greater than 2.0 ppm. In certain embodiments, the catalytically produced nitric oxide is released into the atmosphere at a concentration in the range from 0.5 to 2.0 ppm, 1.0 to 2.0 ppm. 1.5 to 2.0 ppm, 1.0 to 2.00 ppm or 1.5 to 2.0 ppm.

In certain embodiments, the method is performed in a controlled atmosphere setting. In certain embodiments, the method is performed in a cool room, a cold room or a storage room. In certain embodiments, the method is performed in a greenhouse. In certain embodiments, the method is performed in a storage container or a shipping container.

In certain embodiments, the method comprises providing a concentration of nitric oxide in the atmosphere of 0.25 ppm or greater. In certain embodiments, method comprises providing a concentration of nitric oxide in the atmosphere of 0.5 ppm or greater. In certain embodiments, method comprises providing a concentration of nitric oxide in the atmosphere of 1.0 ppm or greater. In certain embodiments, method comprises providing a concentration of nitric oxide in the atmosphere 1.5 ppm or greater. In certain embodiments, method comprises providing a concentration of nitric oxide in the atmosphere of 2.0 ppm or greater.

In certain embodiments, method comprises providing a concentration of nitric oxide in the atmosphere in the range from 0.5 to 2.0 ppm, 1.0 to 2.0 ppm. 1.5 to 2.0 ppm, 1.0 to 2.00 ppm or 1.5 to 2.0 ppm. Other ranges are contemplated.

In certain embodiments, the method reduces ethylene and/or volatile organic compounds in the air or the gas.

In certain embodiments, the method reduces the concentration of volatile organic compounds to 25 ppm or less, or 20 ppm or less. In certain embodiments, the method reduces the concentration of volatile organic compounds in a controlled atmosphere setting containing fruit to 25 ppm or less, or 20 ppm or less.

In certain embodiments, the method reduces the concentration of ethylene to 6.0 ppm or less, or 2.0 ppm or less. In certain embodiments, the method reduces the concentration of volatile organic compounds in a controlled atmosphere setting containing fruit to 6.0 ppm or less, or 2.0 ppm or less.

In certain embodiments, the method is performed at a temperature of ambient temperature, 20° C. or less, 15° C. or less, 10° C. or less, 4° C. or less, or 2° C. or less.

In certain embodiments, the method is performed in a normal oxygen environment, (ie around 21% oxygen). In certain embodiments, the method is performed in a low oxygen environment or atmosphere. In certain embodiments, the method is performed in an atmosphere comprising 5% oxygen or less. In certain embodiments, the method is performed in an atmosphere comprising 2% oxygen or less.

In certain embodiments, the method is performed continuously. In certain embodiments, the method is performed continuously in a controlled atmosphere setting.

In certain embodiments, the irradiating of the metal oxide reduces or removes ethylene and/or volatile organic compounds from the air. In certain embodiments, the irradiating of the metal oxide reduces or removes microorganisms from the air.

In certain embodiments, the method comprises moving air or gas through a hollow body have an inner surface coated with the metal oxide and irradiating the metal oxide as the air or gas moves through the hollow body.

In certain embodiments, the hollow body comprises a tube. Other configurations are contemplated and are described herein.

In certain embodiments, the hollow body comprises an internal length of 50 cm to 300 cm. Other sizes are as described herein.

In certain embodiments, the hollow body comprises a tube and the tube comprises a length of 50 cm to 300 cm and/or an outer diameter of 10 to 30 cm. Other sizes are as described herein.

In certain embodiments, the method comprises one or more means for moving air or a gas through the hollow body. Means for moving air or gas are as described herein.

In certain embodiments, the method comprises a fan to move the air through the hollow tube. Fans are as described herein.

In certain embodiments, the fan comprises a power of 10 to 50 W and/or produces an air flow of 25 to 100 m³ per minute.

In certain embodiments, the fan comprises a power of 10 to 50 W. In certain embodiments, the fan comprises a power of 20 to 50 W, 30 to 50 W, 40 to 50 W, 10 to 50 W, 20 to 40 W, 30 to 40 W, 10 to 30 W, 20 to 30 W, or 10 to 20 W. Other power outputs are contemplated.

In certain embodiments, the fan comprises a power of greater 10 W or greater, 20 W or greater, 30 W or greater, 40 W or greater, or 50 W or greater.

In certain embodiments, the one or more means for moving air or a gas through the hollow body produces an air flow of 25 to 100 m³ per minute. In certain embodiments, the one or more means for moving air or a gas through the hollow body produces a flow of 50 to 100 m³ per minute, 75 to 100 m³ per minute, 25 to 75 m³ per minute, 50 to 75 m³ per minute, or 25 to 50 m³ per minute. Other flow rates are contemplated.

In certain embodiments, the fan produces a flow of 25 to 100 m³ per minute. In certain embodiments, the fan produces a flow of 50 to 100 m³ per minute, 75 to 100 m³ per minute, 25 to 75 m³ per minute, 50 to 75 m³ per minute, or 25 to 50 m³ per minute.

In certain embodiments, the fan produces an air flow of 25 m³ per minute or greater, 50 m³ per minute or greater, 75 m³ per minute or greater, or 100 m³ per minute or greater.

In certain embodiments, the surface comprising a metal oxide comprises a surface embedded with a metal oxide. In certain embodiments, the surface comprising a metal oxide comprises a surface coated with a metal oxide. Methods for coating surfaces are as described herein.

In certain embodiments, the method of coating comprises dipping a surface to be coated in a solution of the metal oxide(s). In certain embodiments, the method of coating comprises painting and/or spraying a surface to be coated with a solution of the metal oxide(s). In certain embodiments, the method of coating comprises dipping a surface to be coated in a solution of the metal oxide(s) and drying the surface. In certain embodiments, the method of coating comprises painting and/or spraying a surface to be coated with a solution of the metal oxide(s) and drying the surface.

In certain embodiments, the metal oxide comprises one or more of a zinc oxide, a titanium oxide, a manganese oxide and a cerium oxide. Other metal oxides and combinations of metal oxides are contemplated.

In certain embodiments, the metal oxide comprises a zinc oxide.

In certain embodiments, the metal oxide comprises a titanium oxide. In certain embodiments, the metal oxide comprises a rutile titanium oxide. In certain embodiments, the titanium dioxide comprises an anatase titanium oxide. In certain embodiments, the metal oxide comprises a rutile titanium oxide and an anatase titanium oxide.

In certain embodiments, the metal oxide comprises a zinc oxide and/or a titanium oxide.

In certain embodiments, the metal oxide comprises a rutile titanium oxide, anatase titanium oxide and zinc oxide.

In certain embodiments, the metal oxide comprises particulates of a size of less than 500 μm. In certain embodiments, the metal oxide comprises particulates of a size of 500 μm or less. Other sizes are contemplated.

In certain embodiments, the metal oxide comprises particulates of a size of less than 500 μm, less than 400 μm, less than 300 μm, less than 200 μm, less than 100 μm, less than 900 nm, less than 800 nm, less than 700 nm, less than 600 nm, less than 500 nm, less than 400 nm, less than 300 nm, less than 200 nm, less than 100 nm, less than 75 nm, less than 50 nm, less than 40 nm, less than 30 nm, less than 20 nm or less than 10 nm. Other sizes are contemplated.

In certain embodiments, the metal oxide comprises particulates of a size 500 μm or less, 400 μm or less, 300 μm or less, 200 μm or less, 100 μm or less, 900 nm or less, 800 nm or less, 700 nm or less, 600 nm or less, 500 nm or less, 400 nm or less, 300 nm or less, 200 nm or less, 100 nm or less, 75 nm or less, 50 nm or less, 40 nm or less, 30 nm or less, 20 nm or less, or 10 nm or less. Other sizes are contemplated.

In certain embodiments, the hollow body is composed of a metal and/or a metal alloy. In certain embodiments, the hollow body is composed of steel. In certain embodiments, the hollow body comprises a tube and the tube is composed of a metal and/or a metal allow, such as a steel. In certain embodiments, the steel comprises a stainless steel. Other materials are as described herein.

In certain embodiments, an inner surface of the hollow body comprising a metal oxide is scored or treated prior to coating with the metal oxide.

In certain embodiments, the inner surface of the hollow body is scored or etched prior to coating with the metal oxide. In certain embodiments, the inner surface of the tube is scored or etched prior to coating with the metal oxide.

In certain embodiments, the surface within the hollow body comprising a metal oxide is chemically scored prior to coating with the metal oxide. In certain embodiments, the surface within the tube comprising a metal oxide is chemically scored prior to coating with the metal oxide. In certain embodiments, the surface within the hollow body comprising a metal oxide is mechanically scored prior to coating with the metal oxide.

In certain embodiments, the surface is scored with a solution comprising a ferric salt and/or a detergent. Examples of ferric salts and detergents are as described herein. Other scoring agents are described herein.

In certain embodiments, the ferric salt comprises ferric chloride.

In certain embodiments, the surface is scored with a solution comprising a concentration of ferric salt of 10 to 25% (w/w). In certain embodiments, the solution comprises a concentration of ferric salt of 10 to 25% (w/w). In certain embodiments, the solution comprises a concentration of ferric salt of 15 to 25% (w/w), 20 to 25% (w/w), 10 to 20% (w/w), 15 to 20% (w/w), or 10 to 15% (w/w). Other concentrations are contemplated.

In certain embodiments, the surface is scored with a solution comprising a concentration of detergent of 2 to 5% (w/w).

In certain embodiments, the solution comprises a concentration of detergent of 2 to 5% (w/w). In certain embodiments, the solution comprises a concentration of detergent of 1 to 5% (w/w), 2 to 5% (w/w), 3 to 5% (w/w), 4 to 5% (w/w), 1 to 4% (w/w), 2 to 4% (w/w), 4 to 4% (w/w), 1 to 3% (w/w), 2 to 3% (w/w) or 1 to 2% (w/w). Other concentrations are contemplated.

In certain embodiments, the detergent comprises an anionic detergent, such as sodium laurel sulphate and/or a derivative thereof. Other detergents are contemplated.

In certain embodiments, the UV light comprises a UV-C light. In certain embodiments, the UV light emits light in a range from 100 to 290 nm. In certain embodiments, the UV light comprises a UV-C lamp or tube. In certain embodiments, the source of UV light has a power output of 8 W or greater, 10 W or greater, 20 W or greater, 30 W or greater, 40 W or greater, 50 W or greater, 60 W or greater, or 70 W or greater.

In certain embodiments, the method produces substantially no ozone.

In certain embodiments, the method reduces the concentration of ethylene in the air, generates NO, reduces the concentration of volatile organic compounds in the air, reduces the rate of deterioration of a fresh product, and/or reduces the concentration of viable microorganism, including spores, in the air.

Examples of fresh products are as described herein. In certain embodiments, the fresh product is fresh plant product.

In certain embodiments, the fresh product comprises a non-plant product. Examples include products such as fresh meats, chicken, cheeses and other dairy products, dried produce, dried meats, smoked products and cured meats. Other types of fresh products are contemplated.

In certain embodiments, the fresh plant product is a product that is susceptible to an ethylene response. In certain embodiments, the fresh plant product is a product that is susceptible to spoilage, deterioration, decay, softening, discolouration or moulding.

In certain embodiments, the fresh plant product comprises a whole plant. In certain embodiments, the plant product comprises a part or portion of a plant.

In certain embodiments, the whole plant comprises one or more of an ornamental plant, a potted plant, a nursery plant, a tree, a shrub, a foliage plant, a flowering plant, a greenery plant, a field crop, a landscape plant, and an agricultural plant.

Examples of plants comprise cotton (Gossypium spp.), apples, pears, cherries (Prunus avium), pecans (Carva illinoensis), grapes (Vitis vinifera), olives (e.g. Vitis vinifera and Olea europaea), coffee (Coffea arabica), snapbeans (Phaseolus vulgaris), and weeping fig (ficus benjamina), as well as dormant seedlings such as dormant seedlings of various fruit trees including apple, ornamental plants, shrubbery, and tree seedlings. In addition, shrubs which may be treated according to the present invention to inhibit an ethylene response, such as abscission of foliage, include privet (Ligustrum sp.), photinea (Photinia sp.), holly (Ilex sp.), ferns of the family Polypodiaceae, schefflera (Schefflera sp.), aglaonema (Aglaonema sp.), cotoneaster (Cotoneaster sp.), barberry (Berberis sp.), waxmyrtle (Myrica sp.), abelia (Abelia sp.), acacia (Acacia sp.) and bromeliades of the family Bromeliaceae. Other types of plants are contemplated. In certain embodiments, the plant product comprises a part or portion of the aforementioned plants.

In certain embodiments, the method is used to inhibit an ethylene response, such as to inhibit abscission of foliage, flowers and fruit.

In certain embodiments, the method is used to inhibit an ethylene response, such as senescence and/or shortening of flower life and thus prolong flower life and appearance (e.g. delay wilting).

Examples of flowering plants comprise azalea (Rhododendron spp.), hydrangea (Macrophylla hydrangea), hybiscus (Hibiscus rosasanensis), snapdragons (Antirrhinum sp.), poinsettia (Euphorbia pulcherima), cactus (e.g. Cactaceae schlumbergera truncata), begonias (Begonia sp.), roses (Rosa spp.), tulips (Tulipa sp.), daffodils (Narcissus spp.), dandelions (Taraxacum offinale), petunias (Petunia hybrida), carnation (Dianthus caryophyllus), lily (e.g., Lilium sp.), gladiolus (Gladiolus sp.), alstroemeria (Alstoemeria brasiliensis), anemone (e.g., Anemone blanda), columbine (Aquilegia sp.), aralia (e.g., Aralia chinensis), aster (e.g., Aster carolinianus), bougainvillea (Bougainvillea sp.), camellia (Camellia sp.), bellflower (Campanula sp.), cockscomb (celosia sp.), falsecypress (Chamaecyparis sp.), chrysanthemum (Chrysanthemum sp.), clematis (Clematis sp.), cyclamen (Cyclamen sp.), freesia (e.g., Freesia refracta), and orchids of the family Orchidaceae. Other types of flowering plants are contemplated. Other types of plants are contemplated. In certain embodiments, the plant product comprises a part or portion of the aforementioned flowering plants.

In certain embodiments, the fresh plant product comprises a part or portion of a plant. In certain embodiments, the fresh plant product comprises a fruit, a vegetable, a cutting, and a cut flower. Other types of plant products are contemplated.

Examples of fruits comprise tomatoes (Lycopersicon esculentum), apples (Malus domestica), bananas (Musa sapientum), pears (Pyrus communis), papaya (Carica papaya), mangoes (Mangifera indica), peaches (Prunus persica), apricots (Prunus armeniaca), nectarines (Prunus persica nectarina), oranges (Citrus sp.), lemons (Citrus limonia), limes (Citrus aurantifolia), grapefruit (Citrus paradisi), tangerines (Citrus nobilis deliciosa), kiwi (Actinidia chinenus), melons such as cantaloupe (C. cantalupensis) and musk melon (C. melo), pineapple (Aranas comosus), persimmon (Diospyros sp.), various other fruits including stone fruits, and berries such as strawberries (Fragaria), blueberries (Vaccinium sp.) and raspberries (e.g., Rubus ursinus), green beans (Phaseolus vulgaris), members of the genus Cucumis such as cucumber (C. sativus), and avocados (Persea americana). Other types of fruits are contemplated.

Examples of vegetables comprise leafy green vegetables, such as lettuce (e.g., Lactuea sativa), spinach (Spinaca oleracea), and cabbage (Brassica oleracea), various roots, potatoes (Solanum tuberosum), carrots (Daucus), bulbs, onions (Allium sp.), herbs, basil (Ocimum basilicum), oregano (Origanum vulgare), dill (Anethum graveolens), soybean (Glycine max), lima beans (Phaseolus limensis), peas (Lathyrus spp.), corn (Zea mays), broccoli (Brassica oleracea italica), cauliflower (Brassica oleracea botrytis), and asparagus (Asparagus officinalis). Other types of vegetables are contemplated.

In certain embodiments, the fresh plant product comprises a part or portion of a plant. In certain embodiments, the method is used to inhibit an ethylene response, to slow ripening, to slow deterioration, to slow the growth of microorganisms, to slow spoilage, and to improve the quality or appearance of the product when stored.

In certain embodiments, the method is used to extend the shelf life of a plant product selected from a fruit, a vegetable, a cut flower, an ornamental plant, a potted plant, a nursery plant, a tree, a shrub, a foliage plant, a flowering plant, and an agricultural plant.

Certain embodiments of the present disclosure provide a method for extending the shelf life a fresh product, the method comprising modifying the air in which the fresh product is present by treating the air using UV irradiation in the presence of a metal oxide, thereby extending the shelf life of the fresh product.

Methods for treating air using UV irradiation in the presence of a metal oxide are as described herein. In certain embodiments, a device as described herein is used to modify or treat the air.

Certain embodiments of the present disclosure provide a method of producing a surface coated with a metal oxide.

In certain embodiments, the surface comprises a metal surface. Other types of surfaces are contemplated.

Certain embodiments of the present disclosure provide a method of producing a metal surface coated with a metal oxide, the method comprising:
chemically scoring the metal surface with a ferric salt and a detergent; and
coating the scored metal surface with the metal oxide.

Metals and metal alloys are as described herein. Chemical scoring is as described herein. Metal oxides are as described herein.

Methods for coating a scored metal are as described herein. Metal oxides are as described herein.

In certain embodiments, the coating comprises coating with a zinc oxide and/or a titanium oxide.

In certain embodiments, the coating comprises applying a pre-coating of one or more of a zinc oxide, a manganese oxide and/or a cerium oxide to the surface, and subsequently applying a coating of a zinc oxide and/or a titanium oxide to the pre-coated surface.

Certain embodiments of the present disclosure provide a method of producing a surface coated with a metal oxide, the method comprising:
scoring the surface;
applying a pre-coating of a one or more of a zinc oxide, a manganese oxide and/or a cerium oxide to the surface; and
applying a coating of a zinc oxide and/or a titanium oxide to the pre-coated surface.

In certain embodiments, the surface comprises a metal surface. In certain embodiments, the surface is chemically scored.

Certain embodiments of the present disclosure provide a method of coating a surface, the method comprising applying a pre-coating of one or more of a zinc oxide, a manganese oxide and/or a cerium oxide to the surface, and subsequently applying a coating of a zinc oxide and/or a titanium oxide to the pre-coated surface.

In certain embodiments, the surface comprises a metal surface.

In certain embodiments, the surface is scored prior to coating. Scoring is as described herein.

Certain embodiments of the present disclosure provide an object comprising a surface coated as described herein. In certain embodiments, the object comprises an inner surface of a tube in a device as described herein, or a sleeve or an insert for use in a device as described herein.

Certain embodiments of the present disclosure provide an air modifying device for extending shelf life of a fresh product, the device comprising:
a metal tube, wherein an inner surface of the tube is coated with (a) a coating comprising a zinc oxide and/or a titanium oxide, or (b) a coating comprising an undercoat of one or more of a zinc oxide, a manganese oxide and/or a cerium oxide and a primary coat of a zinc oxide and/or a titanium oxide;
a fan for moving air or a gas through the metal tube; and
a source of UV light within the tube to direct UV light onto the coated inner surface coated.

The present disclosure is further described by the following description of specific embodiments. It is to be understood that the following description is for the purpose of describing particular embodiments only and is not intended to be limiting with respect to the above description.

### DETAILED DESCRIPTION OF SPECIFIC EMBODIMENTS

### Example 1—Air Modifying Device

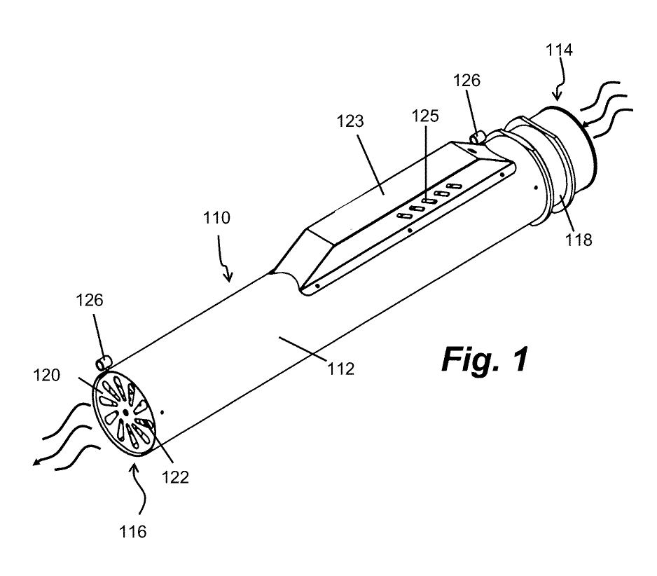

FIG. 1 shows an external view of an air modifying device 110 according to one embodiment.

Referring to FIG. 1, the device 110 comprises a cylindrical stainless steel (UNS S30400—grade 304) tube 112, which typically has a length of 100-300 cm (typically 1.0 m), an outside diameter of 10-20 cm (typically 15 cm) and a thickness of 1 to 3 mm.

The tube 112 of the air modifying device 110 comprises two open ends 114 and 116, which permit air or other gas to move through the tube 112. Inside the tube 112 is a surface coated with a catalytic metal oxide(s) and a UVC lamp (not visible).

In the embodiment shown, a fan unit 118 is located at one end 114 of the device, which draws air into the device from the atmosphere and moves the air through the device 110, so that the air is expelled at the other end 116 of the device. Typically, the fan unit 118 utilises an electrically powered fan of any suitable power, for example approximately 20 W to 50 W and it will be appreciated than the fan can be fitted within or exterior to tube 112.

At the other end of the tube 116 is a vent/air restrictor 120 sleeved into the inside of the tube 112, which assists in circulating the air expelled from the device 110 through the vents 122.

Typically the device is powered by either a 110V power source or a 240V power source. The electrical components are typically housed externally, under a cover 123, which has a number of air vents 125 to assist with cooling the electrical components therein. The device may also have an electronic light on the outside of the device indicating that the device is on/off and/or the UV light within the device is operating. The device may also be remotely controlled, and/or be part of an integrated controlled system.

The device 110 also includes one or means for supporting the device in a vertical and or horizontal position, such as suitable brackets or hooks 126 appropriately placed on the device and which permit hanging or attachment of the device to a wall or ceiling or other object, although it will be appreciated that the device 110 may also be adapted for portable use.

A smaller version of the device 110 may also be produced, and which may be used, for example, as a free-standing unit on legs. Such a device may be used in smaller areas or to supplement the activity of one or more larger units. The smaller device typically has an overall length of around 50 cm and a tube diameter of 10 cm.

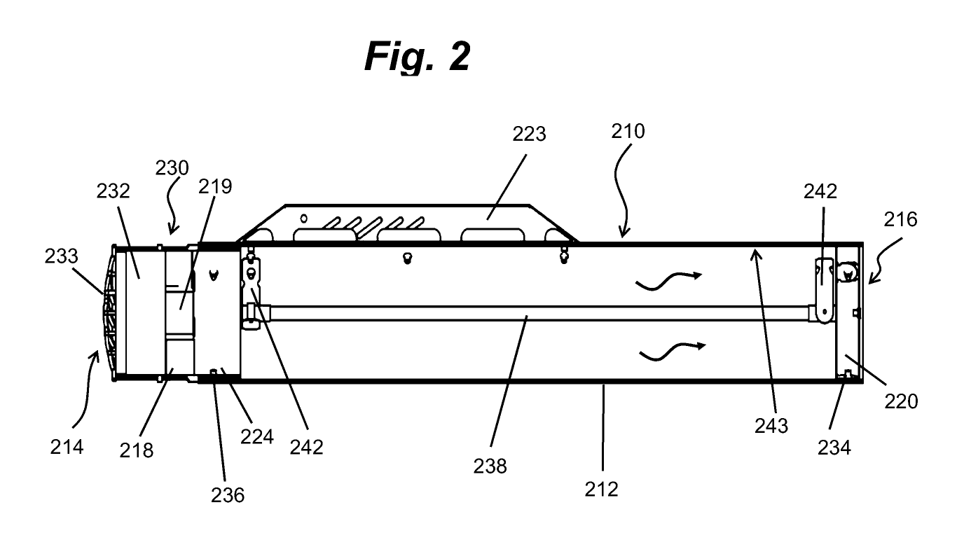

Referring to FIG. 2 there is shown an internal view of the device 210 according to one embodiment. The device 210 comprises a cylindrical stainless steel tube 212, which typically has a length of around 100-300 cm (typically 1 m), an outside diameter of 10-20 cm (typically 15 cm) and a thickness of 1 to 3 mm.

The tube 212 of the air modify device 210 comprises two open ends 214 and 216, which permit air or other gas to move through the tube 212.

In the embodiment shown, a fan unit 218 is located at one end 214 of the device, which draws air into the device from the atmosphere and moves the air through the device 210, so that the air is expelled at the other end 216 of the device. Typically, the fan unit 218 utilises an electrically powered fan unit 218 of approximately 20 W-50 W.

At the other end of the tube 216 is a vent/air restrictor 220 fitted into the inside of the tube 212, and secured to tube 212 by screws 234. The vent/air restrictor 220 assists in circulating the air expelled from the device 210 through the vents (not visible).

The fan unit 218 is located near the end 214 to move air through the tube 212 and uses an electric motor 219. The fan unit 218 is part of a fan assembly 230, which at one end includes a component 224 that slides into the inside of the tube 212 and is screwed to the tube by way of screws 236. The fan assembly 230 also includes an air ingress component 232, which houses the fan blades and also directs air into the device 210. The device 210 may also include a fan cap 233 and/or an air filter (not shown) either before or after the fan unit 218, to remove particulates before they enter the inside of the tube 212.

Inside the tube 212 is located an ultraviolet (UV) lamp 238, which is typically a non-ozone producing 70 W ultraviolet (UV) lamp and which emits in the UVC range. The UV lamp 238 is operated by an electrical junction and suitable lamp ballast, which are positioned under the cover 223. The UV lamp is supported by support brackets 242, using clamps and screws to support the UV lamp 238 positioned at the centre of the tube 212.

The device 210 typically utilises an AC (240V-50 Hz or 110V-60 Hz) supply cable with interior wiring to the UV lamp 238 and the fan unit 218. The device 210 may also include a power monitoring accessory to remotely sense failure of fan or lamp, and/or an electronic light on the device indicating that the device is on and the UV light within the device is operating.

In the embodiment shown, a catalytic coating 243 was applied to the inside surface of the tube 212 so that UV irradiation is directed onto the surface.

However, it will be appreciated that the catalytic coating may only be applied to a portion of the inside surface of the tube 212, or in another embodiment, one or more plates coated with the catalytic coating may be mounted inside the device 212. In another embodiment, replaceable catalyst coated inserts can be used, and can comprise of stainless steel, silica, or a UV resistant substrates on which the catalysts are imbedded.

In the embodiment shown, a catalytic coating 243 is applied to the inside of a stainless steel tube 212.

In the embodiment shown, the coating was applied by first treating the internal surfaces of the stainless steel tube 212 with Ferric Chloride, in conjunction with Sodium Laurel Sulphate (SLS) as a foaming agent. This was performed by dipping the tube in a solution of 15% FeCl₃ and 3% sodium laurel sulphate for 10 minutes. This process provided a scoring effect on the inner surfaces of the tube. Following treatment, the tube was washed with water and allowed to dry. A dry coating of 50% nano zinc oxide (CAS No.: 1314-13-2) and 50% nano titanium oxide (CAS No.: 13463-67-7) was applied as a mixed powder by a hard dry pressed method to the scored internal surfaces to produce the final coating. Whilst the coating applied in the described embodiment utilised a zinc oxide and a titanium oxide (eg rutile titanium oxide and/or anatase titanium oxide), it will be appreciated that other oxides, and mixture of oxides, may be utilised. For example the oxides may comprise a mixture of rutile titanium, anatase titanium oxide and zinc oxide

In the embodiment shown, the device 210 utilises a high output non ozone producing UV lamp 238 housed centrally in the stainless steel tube 212 that has been selectively coated internally with metal oxide catalysts to ablate volatile organic compounds (VOCs) to CO₂ and water, destroy ethylene and also generate and maintain desirable concentrations of nitric oxide (NO) required for optimal storage of fresh produce. Air movement through the tube is achieved by a low wattage electric fan. The net power requirement for operation of the device 210 is below 100 Watts.

The catalytic coating when acted on by UV light provides a number of advantages: (i) producing hydroxyl radical (OH), and generation of NO, at concentrations suitable for prolonging shelf life of fresh produce and significantly reducing downgrade and wastage of fresh produce; (ii) ablating ethylene and Volatile Organic Compounds (VOC's) to retard the senescence and ripening process of fresh plant produce; and (iii) the device acts as biocide, to significantly reduce spoilage due to organisms such as fungal, bacterial, viral and prions.

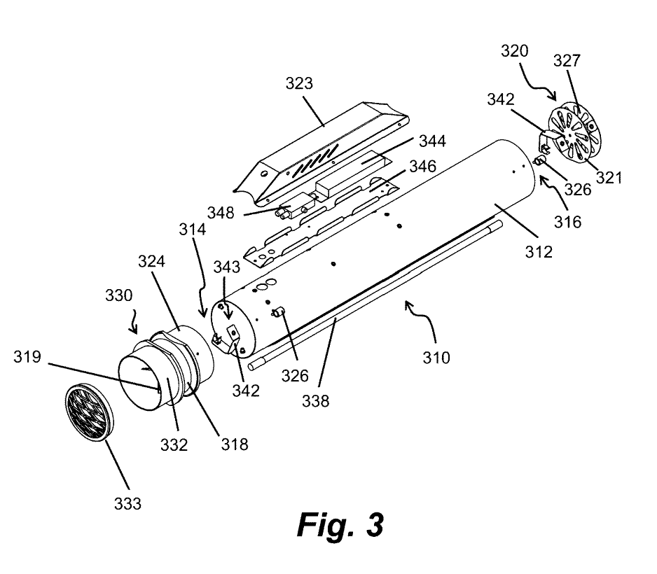

Referring to FIG. 3 there is an exploded view of the device 310 showing some of the components therein. The device 310 comprises a cylindrical stainless steel tube 312, the inside surface of which is coated with a catalytic metal oxide coating 343. The tube 312 of the air modify device 310 comprises two open ends 314 and 316, which permit air or other gas to move through the tube 312.

In the embodiment shown, at one end 314 of the device 310 there is a fan assembly 330, which includes fan unit 318 (with internal fan motor), an air ingress component 332 housing fan blades 319 and which directs air into the device 310, and a component 324 that is received into the tube 312 and is held in place with screws.

The device 310 may also include a fan cap 333 and/or an air filter (not shown) either before or after the fan unit 318, to remove particulates before they enter the inside of the tube 312.

At the other end of the tube 316 is a vent/air diffuser 320, having a front diffuser 321 and a rear diffuser 327. The diffuser 327 assists with circulation of the modified air as it leaves the device 310.

Inside the tube 312 is located an ultraviolet (UVC) lamp 338, which is typically a non-ozone producing 70 W UVC lamp. The UV lamp 338 and other components are operated by an electrical junction 348 and a suitable lamp ballast 344, supported by an electronic ballast tray 346. A cover 323 protects the internal electrical/electronic components.

The UV lamp 338 is supported by support brackets 342, so as to position the UV lamp 338 at the centre of the tube 312, where UV light from the lamp can irradiate the inner surface 343 of the tube coated with metal oxide(s) 312 to produce NO.

The device 310 also includes one or means for supporting the device in a vertical and or horizontal position, such as suitable brackets or hooks 326 appropriately placed on the device and permitting hanging or attachment to a wall or ceiling or other object.

### Example 2—Use of the Air Modifying Device

As described herein, in certain embodiments the device is a photo-catalytic unit utilising a high output ultraviolet (UV) lamp housed in a purpose built stainless steel tube that has been selectively coated internally with catalysts that ablate VOCs to CO₂ and water and also generate and maintain a desirable concentration of NO required for improved storage of fresh produce. Air movement through the tube is achieved by a small fan and the power requirement for its operation is typically less than 100 Watts.

The device provides a maintained low level concentration of NO, typically for use in controlled atmosphere, greenhouses and storage facilities for fresh produce. Controlled atmosphere settings may utilise atmospheric air or be modified to reduce the concentration of oxygen in the atmosphere.

One of the benefits for use of the device is that the removal of VOCs is not addressed by products which release an ethylene inhibitor into the atmosphere to prevent ripening, such as 1-methylcyclopropene. As described herein, the device has demonstrated ability to ablate these troublesome compounds in addition to maintaining NO at concentrations required for long term storage of fresh produce. The capacity of the device to also eliminate air borne micro-organisms including phytopathogens, provides distinct advantages in fresh produce storage as well as in other applications.

Owing to the effective preservation properties of the device described herein, it is also anticipated that refrigeration temperatures of large cool rooms can be raised, providing considerable energy savings, and whilst this aspect is yet to be quantified, trials with flowers and bananas have provided support for this improvement.

Results

The device has been trailed on bins of apples in several Controlled Atmosphere (CA) storage facilities in the Adelaide Hills with outstanding results. In these studies, it was found that the use of the device reduced ripening reduced deterioration and maintained fruit quality.

To provide objective quantification of the parameters responsible for the observed effects, further studies have also been conducted.

An assessment of the device's performance was conducted using a portable “I-BRID MX6” air analyser manufactured by Industrial Scientific. Confirmation analysis of the NO and ethylene concentration was also performed by Drager tubes.

The test environment for the device was a closed space of approximately 10 m³ in volume, at 16° C. and occupied by two adults at the time of testing. A 10 kg box of bananas was left in the room overnight for approximately 8 hours on the previous day to increase VOC and ethylene concentrations. The air output of the device, based on the specification of the fan used, was 75 m³ per minute.

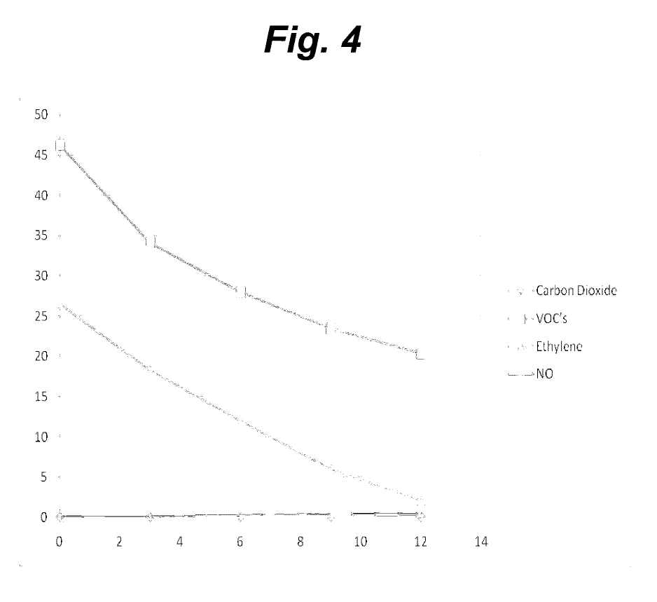

The data obtained with the device is shown in Table 1 and FIG. 4.

TABLE 1

| | Initial | Conc | Conc | Conc at | Conc |
|---|---|---|---|---|---|
| | conc | at 3 min. | at 6 min. | 9 min. | at 12 min. |
| Parameter | (ppm) | (ppm) | (ppm) | (ppm) | (ppm) |
| Oxygen | 20.7 | 20.5 | 20.5 | 20.5 | 20.5 |
| Carbon | 0 | 0 | 0 | 0 | 0 |
| Monoxide | | | | | |
| Carbon Dioxide | 0.05 | 0.05 | 0.07 | 0.08 | 0.1 |
| VOC's | 46.3 | 34.1 | 28.0 | 23.5 | 20.4 |
| Ethylene | 26.5 | 20.2 | 15.7 | 6.0 | 2.1 |
| NO | 0 | 0.11 | 0.25 | 0.39 | 0.50 |
| NO (Drager | 0 | 0.08 | 0.15 | 0.29 | 0.45 |
| tube) | | | | | |

3. Discussion

As can be seen, the device did not affect standing oxygen concentration in the closed space. However, a rapid decrease of VOCs and ethylene, and a corresponding increase in CO₂ is clearly seen from the data, as is an increase in desirable NO concentration.

Accordingly, over a time span of 12 minutes, in a 10 m³ room, changes in air quality parameters were very evident.

Data of VOC and ethylene concentration has also been collected from monitoring 6 controlled atmosphere rooms of capacities ranging from 300 m³ to 500 m³ filled with a range of apple varieties with comparable results with regards to ablation of these compounds as provided above.

An extensive study was also conducted to evaluate the device as a possible means of replacing fungicide dipping of apples in Diphenylamine (DPA). The results of this study confirmed that there were no quantifiable differences in percentage of downgrade of the fruit, implying that DPA dipping could well become unnecessary if a device as described herein is used. The apple varieties used in the full scale controlled atmosphere trials were: Pink Lady, Sundowner and Granny Smith. The senior agronomist who conducted the trial specifically noted “Non dipped fruit was greener, had less waxiness and showed no physical residue on the fruit”. These observations were in contrast to DPA dipped fruit that exhibited the undesirable characteristics of waxy fruit with residue. The ramifications for Organic Certification of fruit are obvious and provide a further benefit of the use of the device.

As the half life of the NO species is relatively short (being approximately 5 minutes in a chemically inert environment at ambient temperature), there is a clear need for a “maintenance concentration” of NO and the device described herein fulfils this requirement, in addition to its attributes of VOC reduction, ethylene reduction and air sterilization.

It will also be appreciated that while the use of the device has been demonstrated in respect of plants products, the use of the device as described herein also extends to other types of fresh produce, such as non-plant products, including fresh meats, chicken, cheeses and other dairy products, dried produce, dried meats, smoked products and cured meats. Such products are also susceptible to deterioration, such as by the action of VOCs and microorganisms in the atmosphere.

### Example 3—Coating Using an Undercoat

An alternative coating methodology was developed and found to provide an improvement to the operative longevity of the metal oxide(s) coating.

The coating methodology utilised the application of an undercoat of zinc oxide and an overcoat of titanium dioxide and zinc oxide.

(i) Undercoat Mixture

A 500 ml mixture of 50% by volume of 99% acetic acid and 30 grams of citric acid crystals was prepared, with the remainder being distilled water. 25 grams of zinc oxide was then added to the mixture.

Manganese oxide and cerium oxide may also be utilised in the undercoat, individually, in combination with each, or in combination with zinc oxide. Typically, the oxide(s) may be used in a similar amount to replace the amount of zinc oxide described above.

(ii) Main Overcoat Mixture

Titanium Dioxide (Anatase)—75% Anatase Titanium Dioxide (63.75 grams) was placed into a beaker. Titanium Dioxide (Rutile)—25% Rutile Titanium Dioxide (21.25 grams) was then added and finally 25% Zinc Oxide (12.75 grams) added.

The mixture of Titanium Dioxide Anatase, Titanium Dioxide Rutile and Zinc Oxide was added to 500 ml of pre heated water (at approx 80° C.) and stirred thoroughly for 3 hours.

(iii) Application Method

Undercoat: A stainless steel tube was scored with ferric chloride and detergent as described in Example 1. Using appropriate physical protection (gloves etc.) the undercoat was then applied by spraying or rolling. Painting is also a suitable application method. The undercoat was applied so as to ensure even coating to give full coverage to within 5 cm of each end of the tube. A high volume fan was then utilised to dry the coating and left running until the coating was visibly dry. Once visibly dry, a UV light was installed and left to operate for a period of 2 days.

Overcoat: The main overcoat mixture was applied to the dried undercoat applied by spraying or rolling. Painting is also a suitable application method. Spraying, rolling or painting are examples of other suitable application methods. The overcoat was applied so as to ensure even coating to give full coverage to within 5 cm of each end of the tube. A high volume fan was then utilised to dry the coating and left running until the coating was visibly dry. Once visibly dry, a UV light was installed and left to operate for a period of 4 days.

The benefit of the above process was that it was found to result in a longer operative shelf life (3 months) of the device and to assist with a slightly thicker operative coating.

Although this example describes the use of the main overcoat mixture in conjunction with an undercoat, it will be appreciated that the tube may also be only coated with the main overcoat mixture.

Although the present disclosure has been described with reference to particular embodiments, it will be appreciated that the disclosure may be embodied in many other forms. It will also be appreciated that the disclosure described herein is susceptible to variations and modifications other than those specifically described. It is to be understood that the disclosure includes all such variations and modifications. The disclosure also includes all of the steps, features, compositions and compounds referred to, or indicated in this specification, individually or collectively, and any and all combinations of any two or more of the steps or features.

Also, it is to be noted that, as used herein, the singular forms “a”, “an” and “the” include plural aspects unless the context already dictates otherwise.

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

Reference to any prior art in this specification is not, and should not be taken as, an acknowledgment or any form of suggestion that this prior art forms part of the common general knowledge in any country.

The subject headings used herein are included only for the ease of reference of the reader and should not be used to limit the subject matter found throughout the disclosure or the claims. The subject headings should not be used in construing the scope of the claims or the claim limitations.

The description provided herein is in relation to several embodiments which may share common characteristics and features. It is to be understood that one or more features of one embodiment may be combinable with one or more features of the other embodiments. In addition, a single feature or combination of features of the embodiments may constitute additional embodiments.

All methods described herein can be performed in any suitable order unless indicated otherwise herein or clearly contradicted by context. The use of any and all examples, or exemplary language (e.g., “such as”) provided herein, is intended merely to better illuminate the example embodiments and does not pose a limitation on the scope of the claimed invention unless otherwise claimed. No language in the specification should be construed as indicating any non-claimed element as essential.

Future patent applications may be filed on the basis of the present application, for example by claiming priority from the present application, by claiming a divisional status and/or by claiming a continuation status. It is to be understood that the following claims are provided by way of example only, and are not intended to limit the scope of what may be claimed in any such future application. Nor should the claims be considered to limit the understanding of (or exclude other understandings of) the present disclosure. Features may be added to or omitted from the example claims at a later date.

Although the present disclosure has been described with reference to particular examples, it will be appreciated by those skilled in the art that the disclosure may be embodied in many other forms.

1-42. (canceled)

43. An air modifying device for extending shelf life of a fresh product, the device comprising:
a hollow body;
one or more means for moving air or a gas through the hollow body;
a surface within the hollow body, the surface comprising a metal oxide; and
a source of UV light within the body to direct UV light onto the surface comprising the metal oxide;
wherein irradiation of the metal oxide with the UV light modifies the air or gas moved through the device so that release of the modified air or gas from the device into the atmosphere around the fresh product extends the shelf life of the fresh product.

44. The device according to claim 43, wherein the hollow body comprises a tube.

45. The device according to claim 44, wherein the tube comprises a length of 50 cm to 300 cm and/or an outer diameter of 10 to 30 cm.

46. The device according to claim 43, wherein the one or means for moving air or gas comprises one or more fans to move air or gas through the device.

47. The device according to claim 43, wherein the metal oxide comprises a zinc oxide and/or a titanium oxide.

48. The device according to claim 47, wherein the titanium oxide comprises a rutile titanium oxide and an anatase titanium oxide.

49. The device according to claim 43, wherein the metal oxide comprises particulates of a size of less than 500 μm.

50. The device according to claim 43, wherein the hollow body is composed of a metal and/or a metal alloy.

51. The device according to claim 50, wherein the hollow body is composed of a steel.

52. The device according to claim 43, wherein the surface comprising a metal oxide comprises substantially the entire inner surface of the hollow body.

53. The device according to claim 50, wherein the hollow body comprises a metal and/or a metal alloy and the surface comprising a metal oxide is coated with the metal oxide.

54. The device according to claim 53, wherein the surface comprising a metal oxide is scored prior to coating with the metal oxide.

55. The device according to claim 54, wherein the surface comprising a metal oxide is scored with a solution of a ferric salt and/or a detergent.

56. The device according to claim 43, wherein the product comprises a plant product or a product selected from a fresh meat, chicken, a cheese, dairy product, dried produce, dried meat, a smoked product and a cured meat.

57. An air modifying device for extending shelf life of a fresh product, the device comprising:
a metal tube, wherein an inner surface of the tube is coated with a metal oxide comprising a titanium oxide and/or a zinc oxide;
a fan for moving air or a gas through the metal tube; and
a source of UV light within the tube to direct UV light onto the inner surface coated with a titanium oxide and/or a zinc oxide;
wherein irradiation of the metal oxide with the UV light modifies the air or gas moved through the device so that release of the modified air or gas from the device into the atmosphere around the fresh product extends the shelf life of the fresh product.

58. A method for extending the shelf life a fresh product, the method comprising using an air modifying device according to claim 43 to extend the shelf life of the fresh product.

59. The method according to claim 58, wherein the method is used to slow ripening of a plant product, to slow deterioration of the product, to slow growth of microorganisms on the product, to slow spoilage of the product, and/or to improve the quality and/or appearance of the product.
